(19) United States
(12) Patent Application Publication
(10) Pub. No.: US 2007/0011036 A1
(43) Pub. Date: Jan. 11, 2007

(54) System, method and computer program product for analyzing salary

(76) Inventor: Yeh-Chyn Lo, Taipei (TW)

Correspondence Address: LADAS & PARRY, 26 WEST 61ST STREET, NEW YORK, NY, 10023, US

(21) Appl. No.: 11/178,887

(22) Filed: Jul. 11, 2005

(51) Int. Cl. G06F 17/60

(52) U.S. Cl. 705/7

(57) ABSTRACT

A system for analyzing compensations includes a display device capable of showing a compensation comparison between a particular entity and a pay structure in character and in graph simultaneously, and also capable of showing a compensation comparison between an instantaneously-inputted entity and a pay structure in character and in graph simultaneously. The system allows employers to analyze a salary or pay status when proceeding with salary adjustment, position transfer, promotion, employment of the entity. A method and a computer program product for analyzing compensations are to show a compensation comparison in character and in graph simultaneously and instantaneously.

### BACKGROUND OF THE INVENTION

1. Field of the Invention

The present invention relates to a system, a method and a computer program product for analyzing salaries and, more particularly, relates to a system, a method and a computer program product for analyzing salaries in character and in graph simultaneously.

2. Descriptions of the Related Art

A pay structure is important to the compensation management of a company or an organization. To facilitate the compensation management, employers or executives usually classify similar jobs into the same pay grade through a process of job analysis, job description and job evaluation. A variety of pay grades are hence generated. All of these pay grades from a bottom grade to a top grade are then leveled up as a pay structure. Each pay grade includes information of the job titles, a salary minimum and a salary maximum. Both the pay grades and the pay structure may be regarded as a reference material to offer or to adjust employees' salary.

U.S. Pat. No. 5,819,231 discloses a compensation planning tool and method. The compensation planning tool includes a compensation planner and a report generator. The compensation planner is configured to store compensation information for employees and a salary guideline which includes a range of salary and a total salary maximum. The compensation planner sorts employees by rank and displays a compensation plan. The report generator is configured to generate a report from the compensation plan. The report shows a representation of compensation information including a current salary and a planned total compensation for each employee. The planned total compensation includes a base pay, a bonus and a correlation between the rank and the total compensation of the employees. The method for planning compensation includes the steps of: receiving compensation information for employees; storing the compensation information for each employee; sorting the employees by rank; generating a compensation plan including a current total compensation and a planned total compensation; displaying the compensation plan; generating a report from the compensation plan; and displaying a correlation between the rank and the total compensation of the employees in the compensation plan.

U.S. Pat. No. 6,735,571 discloses a compensation prediction system and method. The system includes a communications network interface, a storage device and a processor. The communications network interface is configured to be coupled to a communication network. The storage device is configured to store compensation data. The processor is configured to be coupled to the communications network interface and the storage device, and to determine a factor to create a regression equation based on linear equations in one or two dimensions or non-linear equations in multiple dimensions in order to calculate estimated compensation for each job. The method includes the steps of: obtaining compensation data; examining the compensation data; standardizing the compensation data; determining factors associated with market compensation data such as industry field, seniority, size of organization; determining base values such as a ratio between an average compensation of a job in a particular industry and an average compensation of all industries; estimating a compensation regressively and deriving a ratio between the estimated compensation and provided compensation as an adjustable variable of the base values; and comparing the estimated compensation with the provided compensation to determine whether at least one criterion is satisfied, wherein the criterion may be the magnitude differences of the estimated compensation and the provided compensation. When a compensation is estimated, some other factors, e.g. original compensation data, also may be taken in consideration to improve the accuracy of compensation estimation.

However, the aforementioned prior art cannot transform a preestablished pay structure into a coordinate plane; further, cannot try to compare compensation datum for employees with the coordinate plane. Besides, the aforementioned prior art also fails to dynamically analyze an instantaneously-inputted compensation datum in contrast with a pay structure. Therefore, employers or executives still need a real-time and instantaneously viewable tool to analyze salaries or pay statuses when a salary adjustment, a job transfer, a promotion, or an employment is under consideration.

### SUMMARY OF THE INVENTION

An object of the present invention is to provide a compensation analysis system for analyzing a salary or pay status of a particular entity in contrast with a pay structure in character and in graph simultaneously. The compensation analysis system includes a database, a first calculation device and a display device. The database is configured to store a compensation datum of the particular entity and information of the pay structure. The first calculation device is configured to calculate a plurality of statistical values according to the pay structure. The display device is configured to simultaneously display a first portion and a second portion, wherein the first portion includes the compensation datum in character, and the second portion includes a coordinate plane in which the plurality of statistical values and the compensation datum are mapped.

Another object of the present invention is to provide a compensation analysis system for a user to instantaneously analyze a salary or pay status of a target entity in contrast with a pay structure in character and in graph simultaneously. The compensation analysis system includes a database, a first calculation device, an input device and a display device. The database is configured to store information of the pay structure. The first calculation device is configured to calculate a plurality of statistical values according to the pay structure. The input device is configured for the user to input a compensation datum of the target entity. The display device is configured to simultaneously display a first portion and a second portion, wherein the first portion includes the compensation datum in character, and the second portion includes a coordinate plane in which the plurality of statistical values and the compensation datum are mapped.

Another object of the present invention is to provide a compensation analysis method. More specifically, this object is to provide a method for analyzing a salary or pay status of a particular entity in contrast with a pay structure in character and in graph simultaneously. The particular entity is a member of a group, and each member of the group has a corresponding compensation datum. The method includes the steps of: obtaining the compensation datum of each member of the group and information of the pay structure; mapping the pay structure and each member of the group into a coordinate plane; receiving a selection of the particular entity in the coordinate plane; and displaying the compensation datum of the particular entity in character.

Another object of the present invention is to provide a compensation analysis method for instantaneously analyzing a salary or pay status of a target entity in contrast with a pay structure. The method includes the steps of: obtaining information of the pay structure; mapping the pay structure into a coordinate plane; receiving a compensation datum of the target entity; and mapping the target entity into the coordinate plane instantaneously.

Another object of the present invention is to provide computer program products including computer readable storage mediums which have computer readable program code embodied therein to perform the above-mentioned methods and the operations of the above-mentioned systems together or separately.

The detailed technology and preferred embodiments implemented for the present invention are described in the following paragraphs accompanying the appended drawings for people skilled in this field to well appreciate the features of the claimed invention.

### BRIEF DESCRIPTION OF THE DRAWINGS

FIG. 1 illustrates a first embodiment of the present invention;

FIG. 2 illustrates a coordinate plane created based on some statistical values in accordance with the first embodiment;

FIG. 3 illustrates a display device of the first embodiment;

FIG. 4 illustrates a second embodiment of the present invention;

FIG. 5 illustrates a display device of the second embodiment;

FIG. 6 illustrates a third embodiment of the present invention;

FIG. 7 illustrates a coordinate plane of a second portion in accordance with the third embodiment;

FIG. 8 illustrates a fourth embodiment of the present invention;

FIG. 9 illustrates a display device of the fourth embodiment;

FIG. 10 illustrates a fifth embodiment of the present invention;

FIG. 11 illustrates a display device of the fifth embodiment;

FIG. 12 illustrates a sixth embodiment of the present invention;

FIG. 13 illustrates a coordinate plane of a second portion in accordance with the sixth embodiment;

FIG. 14 illustrates a flow chart in accordance with a seventh embodiment of the present invention;

FIG. 15 illustrates a further flow chart when a mapping step is executed in accordance with the seventh embodiment;

FIG. 16 illustrates a further flow chart when a step of displaying indexes is executed in accordance with the seventh embodiment;

FIG. 17 illustrates a further flow chart when a step of displaying a regression line is executed in accordance with the seventh embodiment;

FIG. 18 illustrates a further flow chart when a step of generating a regression line is executed in accordance with the seventh embodiment;

FIG. 19 illustrates a flow chart in accordance with an eighth embodiment of the present invention;

FIG. 20 illustrates a further flow chart in accordance with an eighth embodiment of the present invention; and

FIG. 21 illustrates a further flow chart when a step of displaying indexes is executed in accordance with the eighth embodiment.

### DESCRIPTION OF THE PREFERRED EMBODIMENT

The term “compensation” herein includes cash and non-cash rewards, the term “pay” herein includes all cash rewards such as base salaries, bonuses and allowances, and the term “salary” herein means a base salary.

### First Embodiment

A first embodiment of the present invention is a compensation analysis system for an executive of a company to analyze the salary or pay status of a particular entity, for example, a particular engineer, in contrast with a preestablished pay structure of the company. The executive herein refers to the person who is authorized to make a compensation decision. Based on delegation systems of organizations and companies, the person may be a human resource executive, a CFO, a CEO or a general manager. The preestablished pay structure of the company herein is a pay structure predeveloped by the executive particularly for all employees or certain jobs. Each grade of the pay structure at least includes midpoints and range spreads as Table 1 shows:

TABLE 1

| | pay grade | | |
|---|---|---|---|
| | first grade | second grade | third grade |
| midpoint | 40000 | 44000 | 50000 |
| range spread | 10% | 20% | 22% |

wherein the first grade refers to a range of the job points from 300 to 400, the second grade refers to a range of the job points from 400 to 500, and the third grade refers to a range of the job points from 500 to 600. For instance, the compensation data of the current engineers in the R&D department are shown in Table 2:

TABLE 2

| employee no. | pay grade | salary/yr |
|---|---|---|
| 001 | 1^{st} grade | 40500 |
| 002 | 1^{st} grade | 38500 |
| 003 | 2^{nd} grade | 45000 |
| 004 | 2^{nd} grade | 49000 |
| 005 | 2^{nd} grade | 43200 |
| 006 | 2^{nd} grade | 39500 |
| 007 | 3^{rd} grade | 52000 |
| 008 | 3^{rd} grade | 49000 |

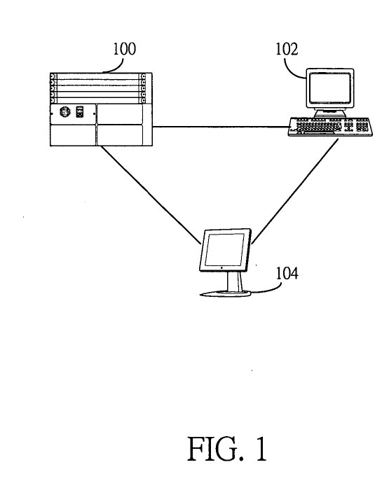

The compensation analysis system of this embodiment, as FIG. 1 shows, includes a database 100, a first calculation device 102 and a display device 104. The database 100 may be any kind of hardware device for storing electronic data and is configured to store the compensation data of the current engineers and the information of the preestablished pay structure, i.e., the data shown in Tables 1 and 2. The first calculation device 102 may be any kind of hardware device performing calculation functions and is configured to calculate a plurality of statistical values according to the pay structure stored in the database 100. The statistical values of each pay grade include a salary minimum, a salary maximum, a first quartile, a midpoint (a second quartile), a third quartile, a range spread, and a midpoint progression. As described above, the midpoint and the range spread are preestablished. The other statistical values may be derived by the following equations:

$$salary minimum = midpoint / ( 1 + range spread \times \frac{1}{2} )$$

$$salary maximum = salary minimum \times ( 1 + range spread )$$

$$first quartile = salary minimum \times ( 1 + range spread \times \frac{1}{4} )$$

$$third quartile = salary minimum \times ( 1 + range spread \times \frac{3}{4} )$$

$$midpoint progression = ( midpoint of the higher pay grade - midpoint of the adjacent lower pay grade ) / midpoint of the adjacent low er pay grade$$

In addition to the above equations, these statistical values may also be derived from some other equations with similar statistical meanings, such as

$$salary minimum = midpoint \div \sqrt{} ( 1 + range spread )$$

$$salary maximum = midpoint \times \sqrt{} ( 1 + range spread )$$

$$first quartile = midpoint \div \sqrt{} ( 1 + range spread \times \frac{1}{2} )$$

$$third quartile = midpoint \times \sqrt{} ( 1 + range spread \times \frac{1}{2} )$$

It is worth noting that the present invention does not confine the equations to generate the statistical values as above only. Besides, more statistical values such as a mode and a variance can also be applied.

According to the aforementioned equations, the first calculation device 102 calculates the statistical values as shown in Table 3:

TABLE 3

| | first grade | second grade | third grade |
|---|---|---|---|
| salary maximum | 41905 | 48000 | 54954 |
| third quartile | 40952 | 46000 | 52477 |
| midpoint(preestablished) | 40000 | 44000 | 50000 |
| first quartile | 39047 | 42000 | 47522 |
| salary minimum | 38095 | 40000 | 45045 |
| range spread(preestablished) | 10% | 20% | 22% |
| midpoint progression | NA % | 10% | 14% |

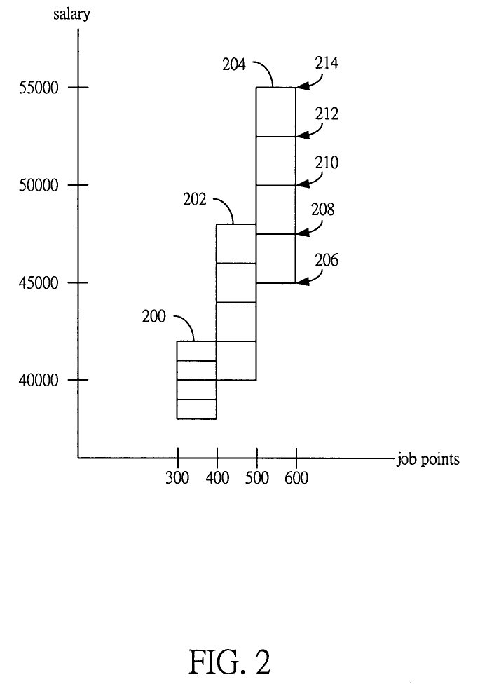

The display device 104 may be any kind of hardware device performing display functions, e.g. a personal computer or a workstation with a monitor. Based on the data shown in Table 3, the display device 104 is able to transform these data from characters into a coordinate plane. FIG. 2 shows the coordinate plane transformed from part of statistical values in Table 3, wherein the x-coordinate denotes job points and the y-coordinate denotes a salary. The percentile bars manifested in the coordinate plane represent the pay structure of the first grade 200, the second grade 202 and the third grade 204 respectively. Referring to the third grade 204 as an example, the salary minimum 206 is US$45045, the first quartile 208 is US$47393, the midpoint 210 is US$50000, the third quartile 212 is US$52477 and the salary maximum 214 is US$54954.

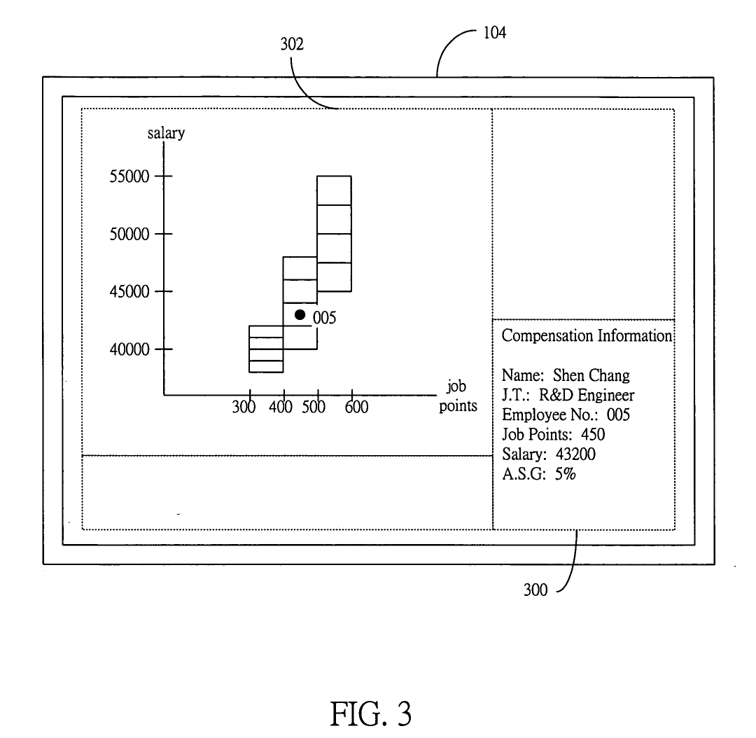

As FIG. 3 shows, the display device 104 displays a first portion 300 and a second portion 302 simultaneously. The first portion 300 is compensation information in character, and the second portion 302 is the coordinate plane in which the plurality of statistical values and the compensation datum of the particular engineer are mapped. If the executive would like to check the salary or pay status of the particular engineer whose employee number is 005, the first portion 300 is the compensation information of the employee number 005 in character, including name of the engineer, job title (J.T.), employee number, job points, salary, and average salary growth (A.S.G.). The second portion 302 includes the coordinate plane showing the pay structure of FIG. 2 as well as the location of the employee number 005 corresponding to the pay structure according to his compensation datum. The average salary growth (A.S.G.) herein refers to an average growth rate of salaries in the latest three years, which is retrieved from the database 100.

With reference to FIG. 3, the compensation of the employee number 005, Shen Chang, falls within the second grade of the preestablished pay structure of the company. More particularly, it is lower than the midpoint of the second grade and higher than the first quartile of the second grade. By means of the simultaneous display of the first portion 300 and the second portion 302, the executive may observe Shen Chang's salary or pay status instantaneously when he reviews Shen Chang's salary adjustment, job transfer and promotion.

Although the database 100, the first calculation device 102 and the display device 104 shown in FIG. 1 are separate devices in this embodiment, the present invention does not confine that these devices must be separate. In other words, any single device, such as a personal computer, a server, or a workstation, able to perform the above-mentioned functions is still embodied.

### Second Embodiment

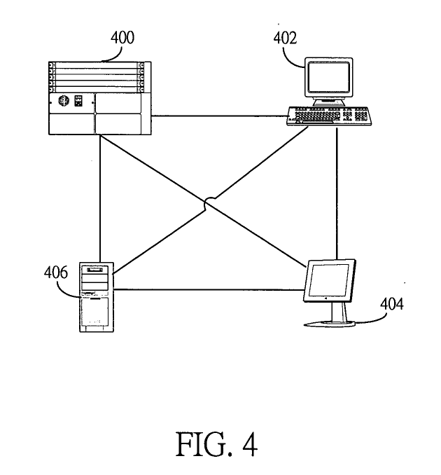

The second embodiment of the present invention is also a compensation analysis system for an executive of a company to analyze a salary or pay status of a particular entity in contrast with a preestablished pay structure of the company and a compensation distribution of a group the particular entity locates in. As shown in FIG. 4, the compensation analysis system includes a database 400, a first calculation device 402, a display device 404 and a second calculation device 406. The database 400, the first calculation device 402, and the display device 404 are similar to the database 100, the first calculation device 102, and the display device 104 so the function descriptions may be referred to the former devices. To facilitate illustration, the second embodiment continues using the data and values shown for the first embodiment, i.e. Tables 1-3.

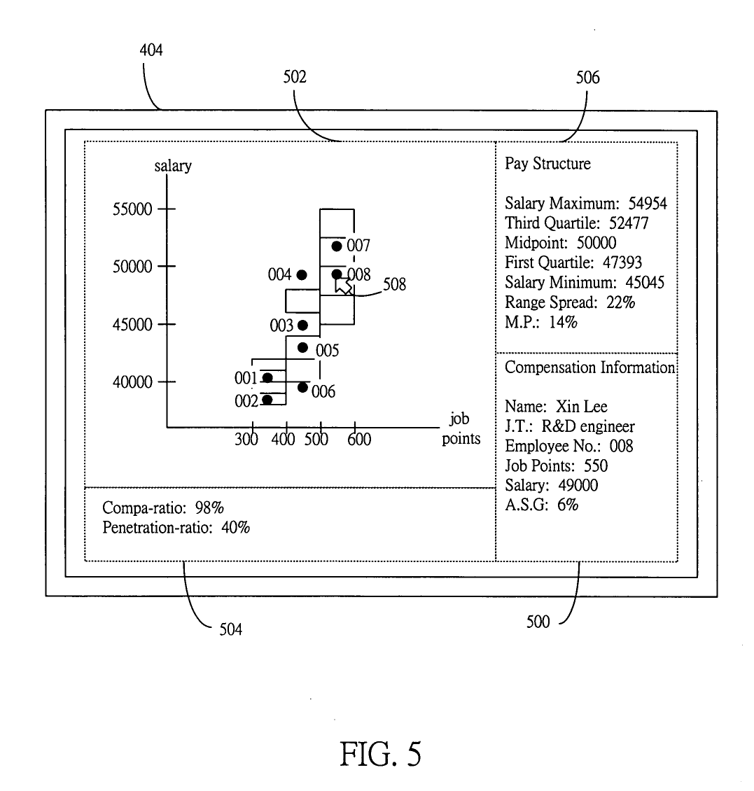

FIG. 5 shows the display device 404. As FIG. 5 shows, the display device 404 maps each member of the group, namely each engineer of the R&D department, into a coordinate plane and displays the locations corresponding to the pay structure in a second portion 502. For example, the job points and the salary of the employee number 003 are 450 and US$45000 respectively, therefore the location of the employee number 003 mapped into the coordinate plane appears in the block bounded between the midpoint and the third quartile of the second grade. If the executive needs to analyze the salary or pay status of the employee number 008, the engineer is selected by a particular way, e.g., by moving a mouse pointer 508 onto the circular point of the employee number 008 in the second portion 502. Once the mouse pointer 508 is moved onto the circular point of the employee number 008, the first portion 500 displays the compensation information of the employee number 008. In addition to observing the salary or pay status of the employee number 008, Xin Lee, in contrast with the pay structure, the executive also may observe Xin Lee's salary in contrast with the salaries of the other engineers when considering Xin Lee's salary adjustment, position transfer and promotion.

To facilitate observation, the second portion 502 may mark each engineer in a corresponding color according to the statistical values. For each pay grade of this embodiment, the engineers with salaries lower than the salary minimum are marked in green, the engineers with salaries between the salary minimum and the first quartile are marked in black, the engineers with salaries between the first quartile and the midpoint are marked in blue, the engineers with salaries between the midpoint and the third quartile are marked in purple, the engineers with salaries between the third quartile and the salary maximum are marked in yellow, the engineers with salaries higher than the salary maximum are marked in red, and the engineers with job points smaller than 300 or larger than 600 are marked in gray. Accordingly, in the second portion 502, the employee number 001 is marked in purple, the employee number 002 is marked in black, the employee number 003 is marked in purple, the employee number 004 is marked in red, the employee number 005 is marked in blue, the employee number 006 is marked in green, the employee number 007 is marked in purple, and the employee number 008 is marked in blue.

Referring to FIG. 4 and FIG. 5, the second calculation device 406 of the compensation analysis system is configured to calculate a plurality of indexes corresponding to the particular engineer according to the statistical values generated from the first calculation device 402 and the compensation data stored in the database 400. The display device 404 simultaneously displays a third portion 504 which includes the plurality of indexes. The indexes herein include a compa-ratio and a penetration-ratio which may be derived from the following equations:
compa-ratio(%)=salary of the particular engineer/midpoint of the pay grade the particular engineer locates in
penetration-ratio(%)=(salary of the particular engineer−salary minimum of the pay grade the particular engineer locates in)/(salary maximum of the pay grade the particular engineer locates in−salary minimum of the pay grade the particular engineer locates in)
For example, the compa-ratio of the employee number 008 is

$$\frac{49000}{50000} \times 100 \% = 98 \%$$

and the penetration-ratio of the employee number 008 is

$$\frac{( 49000 - 45045 )}{( 54954 - 45045 )} \times 100 \% = 40 \% .$$

When the executive moves the mouse pointer 508 onto the circular point of the employee number 008, the third portion 504 instantaneously displays the information of the corresponding compa-ratio and penetration-ratio for the executive to refer. According to the two indexes, the salary of the employee number 008 is very close to the midpoint of the pay grade.

Furthermore, the display device 404 may simultaneously display a fourth portion 506 which includes some of the statistical values corresponding to the pay grade the particular engineer locates in. For example, when the executive moves the mouse pointer 508 onto the circular point of the employee number 008 in the second portion 502, the fourth portion 506 instantaneously displays the salary maximum, the third quartile, the midpoint, the first quartile, the salary minimum, the range spread and the midpoint progression (M.P.) of the third grade for the executive to refer.

The executive may observe the alteration of the salary or pay status of one engineer directly. To do so, the executive simply moves the circular point denoting the engineer to the location denoting a salary and job points the executive intends to offer to the engineer in the coordinate plane. The first portion 500 will show the corresponding compensation information instantaneously in response to the alteration of the salary or pay status of the engineer. To move the circular point denoting the engineer, the executive may move the mouse pointer 508 onto the circular point denoting the engineer, press the left button of the mouse, and move the circular point toward the location denoting the salary and the job points the executive intends to offer in the coordinate plane before releasing the left button. For example, if the executive wants to observe the alterant salary or pay status of the employee number 008, the executive just moves the mouse pointer 508 onto the circular point denoting the employee number 008, presses the left button of the mouse, and moves the circular point toward the location denoting the salary and the job points the executive intends to offer in the coordinate plane before releasing the left button.

### Third Embodiment

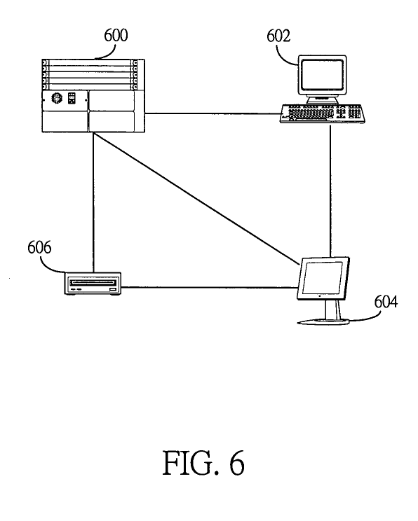

The third embodiment of the present invention is also a compensation analysis system for an executive to analyze a salary trend of a particular group. As FIG. 6 shows, the compensation analysis system includes a database 600, a first calculation device 602, a display device 604 and a regression analysis device 606. The database 600, the first calculation device 602, and the display device 604 are similar to the database 100, the first calculation device 102, and the display device 104 shown in FIG. 1 so the function descriptions may be referred to the former devices. To facilitate illustration, the third embodiment continues using the data and values shown for the first embodiment, i.e., Tables 1-3.

The regression analysis device 606 is configured to generate a regression line according to the compensation datum of each member (each engineer) of the group. More specifically, the regression analysis device 606 presets a first equation, a second equation and a third equation, and calculates a first R² coefficient of determination corresponding to the first equation, a second R² coefficient of determination corresponding to the second equation, and a third R² coefficient of determination corresponding to the third equation according to the compensation datum of each engineer. The first equation, the second equation and the third equation may be any of a linear equation, a quadratic equation, a cubic equation, an exponential equation and a logarithmic equation. According to criterion of lease squares, an R² coefficient of determination refers to the proportion of variance in the Y variable that is in common with variance in X variable. In other words, the regression line can predict the proportion. Therefore, the larger an R² coefficient of determination is, the better fitness the regression line represents. The regression line generated by the regression analysis device 606 is determined by selecting the equation which generates the largest R² coefficient of determination among the first, second and third R² coefficients of determination. If the second R² coefficient of determination is, for example, the largest one among the three, the regression line represents the second equation automatically or manually.

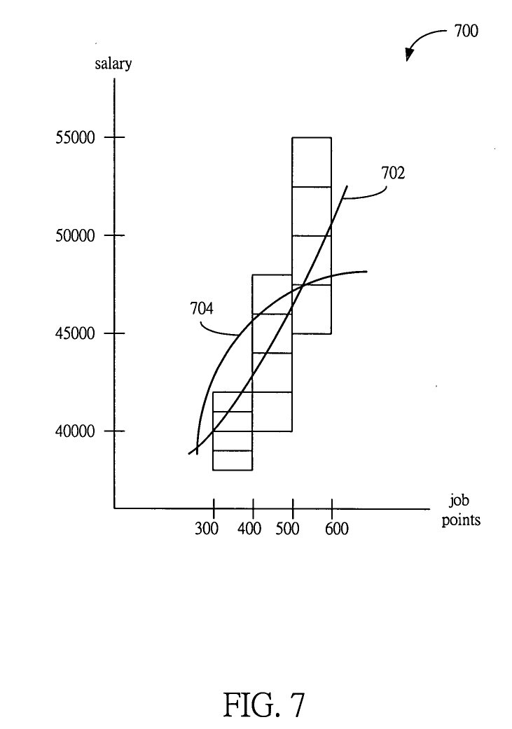

FIG. 7 shows a second portion 700 of the display device 604. As FIG. 7 shows, the second portion 700 includes a regression line 702 which is derived by taking all of the engineers into consideration, so the regression line 702 denotes the salary trend of the R&D department. Referring to the regression line 702, the executive may observe that an engineer within a higher pay grade earns a much more salary. Inevitably, the human resource cost of the R&D department will increase significantly if many engineers are within a high pay grade.

If the database 600 stores compensation data for the same jobs in the market, the regression analysis device 606 can calculate a market regression line 704 based on the salary data for the same jobs. With comparing the regression line 702 and the market regression line 704, the executive may conclude that the salary level of the engineers within a low pay grade in the company is lower than that of other companies in the same business, but the compensation level of the engineers within a high pay grade in the company is much higher than that of other companies in the same business. The executive may also conclude that the salary trend of the R&D department in the company is quite different from that of other companies in the market. The executive might consider adjusting the preestablished pay structure of the company to meet the trend of the market.

The regression analysis device 606 is capable of executing other regression analyses for the executive to make a compensation decision based on different criteria. Using educational attainments as an example, the regression analysis device 606 may generate different regression lines which respectively represent the salary trend of the engineers with a bachelor's degree, the salary trend of the engineers with a master's degree, and the salary trend of the engineers with a doctor's degree. The display device 604 may display these regression lines in the second portion 700 as well for the executive to refer.

### Fourth Embodiment

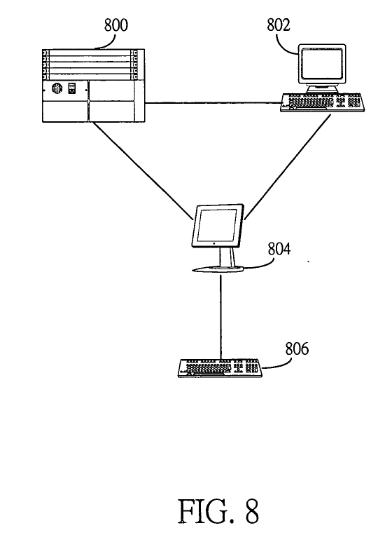

The fourth embodiment of the present invention is a compensation analysis system for an executive to instantaneously analyze a salary or pay status of a target entity in contrast with a pay structure. As FIG. 8 shows, the compensation analysis system includes a database 800, a first calculation device 802, a display device 804 and an input device 806. The database 800, the first calculation device 802, and the display device 804 are similar to the database 100, the first calculation device 102, and the display device 104 shown in FIG. 1 so the function descriptions may be referred to the former devices. The input device 806 is configured for the executive to input a compensation datum of the target entity instantaneously. The inputted compensation datum will be displayed in a first portion and a second portion of the display device 804. To facilitate illustration, the fourth embodiment continues using the data and values shown for the first embodiment, i.e., Tables 1-3.

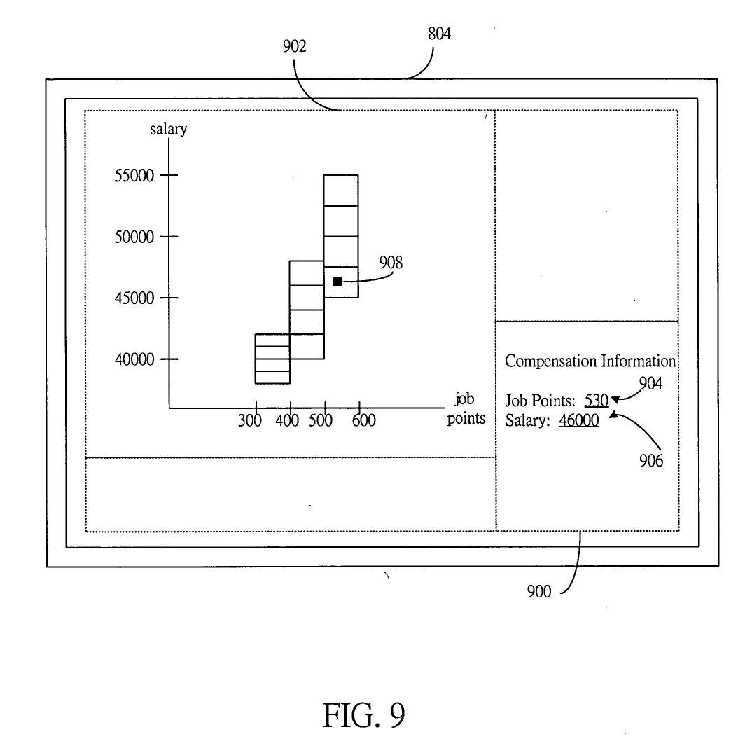

FIG. 9 shows the display device 804. In this embodiment, a first portion 900 includes a job-points column 904 and a salary column 906. The input device 806 may be, for example, a keyboard. When the executive keys in job points and a salary for the target entity through the input device 806, the job-points column 904 and the salary column 906 of the first portion 900 will display what is inputted instantaneously in character; meanwhile, the second portion 902 will display a rectangular point 908 corresponding to what is inputted in a coordinate plane. For example, if the executive keys in “530” in the job-points column 904 and “46000” in the salary column 906, the second portion 902 will instantaneously display the corresponding rectangular point 908 in the coordinate plane to show the relationship between the salary or pay status of the target entity and the pay structure. Alternatively, the input device 806 may be a mouse. When the executive clicks the left button of the mouse at a certain location in the coordinate plane, a rectangular point will appear at the location and the first portion 900 will display compensation information corresponding to the location of the coordinate plane instantaneously. The executive may observe the salary or pay status of the target entity in contrast with the pay structure thereby.

### Fifth Embodiment

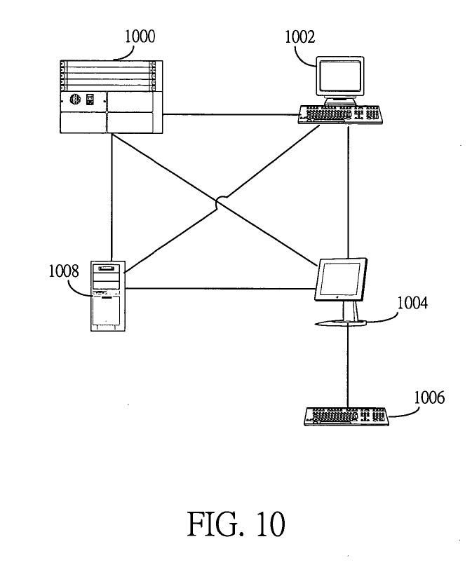

The fifth embodiment of the present invention is also a compensation analysis system. As FIG. 10 shows, the compensation analysis system includes a database 1000, a first calculation device 1002, a display device 1004, an input device 1006 and a second calculation device 1008. The database 1000, the first calculation device 1002, the display device 1004 and the input device 1006 are similar to the database 800, the first calculation device 802, the display device 804 and the input device 806 of the fourth embodiment so the function descriptions may be referred to the former devices. The second calculation device 1008 is configured to calculate a plurality of indexes corresponding to the target entity according to the statistical values generated from the first calculation device 1002 and the compensation datum stored in the database 1000. To facilitate illustration, the fifth embodiment continues using the data and values shown for the first embodiment, i.e., Tables 1-3, wherein each engineer listed in Table 2 is regarded as a reference entity. The inputted target entity may be analyzed in view of the reference entities instantaneously.

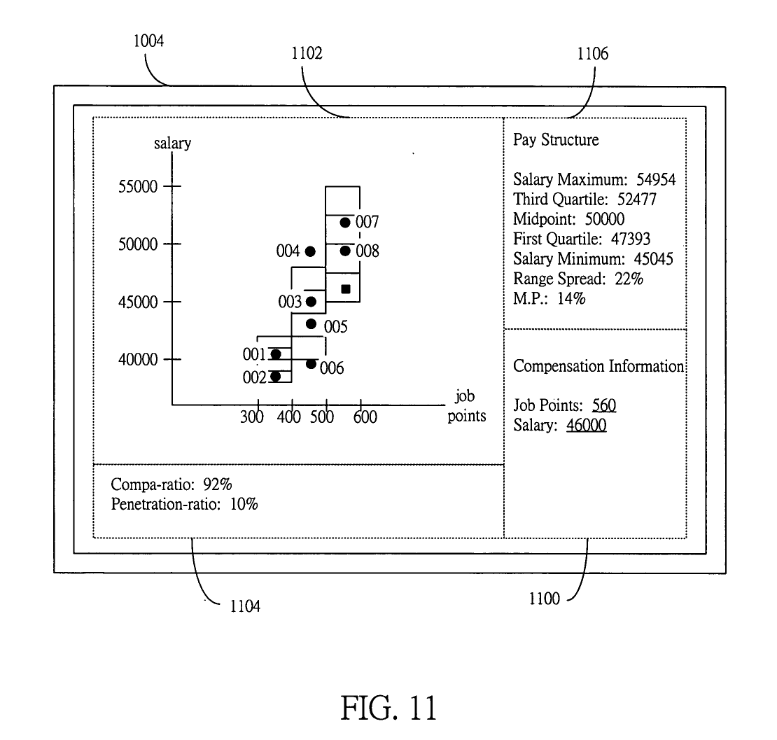

FIG. 11 shows the display device 1004. As FIG. 11 shows, the display device 1004 displays a first portion 1100, a second portion 1102, a third portion 1104 and a fourth portion 1106. The first portion 1100 and the second portion 1102 are similar to the first portion 900 and the second portion 902 of the fourth embodiment. The indexes shown in the third portion 1104 and the statistical values shown in the fourth portion 1106 are derived as the same as those described in the second embodiment. It is noted that the indexes in the third portion 1104 are calculated based on the salary of the target entity and the statistical values in the fourth portion 1106 are calculated based on the pay grade the target entity locates in.

As described above, the second portion 1102 may mark the target entity and the reference entities in a different color in the coordinate plane depending on where they locate. Besides, the target entity and the reference entities may be also marked in other ways. For example, the target entity is marked as a rectangular point and the reference entities are marked as circular points as FIG. 11 shows, or the target entity is marked with glittering, and the reference entities are marked without glittering. The visual distinction between the target entity and the reference entities can call better attention thereby.

### Sixth Embodiment

The sixth embodiment of the present invention is also a compensation analysis system for an executive to analyze how the salary of a target entity affects the salary trend of a particular group. As FIG. 12 shows, the compensation analysis system includes a database 1200, a first calculation device 1202, a display device 1204, an input device 1206 and a regression analysis device 1208. The database 1200, the first calculation device 1202, the display device 1204, and the input device 1206 are similar to the database 1000, the first calculation device 1002, the display device 1004, and the input device 1006 shown in FIG. 10. The regression analysis device 1208 is similar to the regression analysis device 606 shown in FIG. 6. To facilitate illustration, the sixth embodiment continues using the data and values shown for the first embodiment, i.e., Tables 1-3.

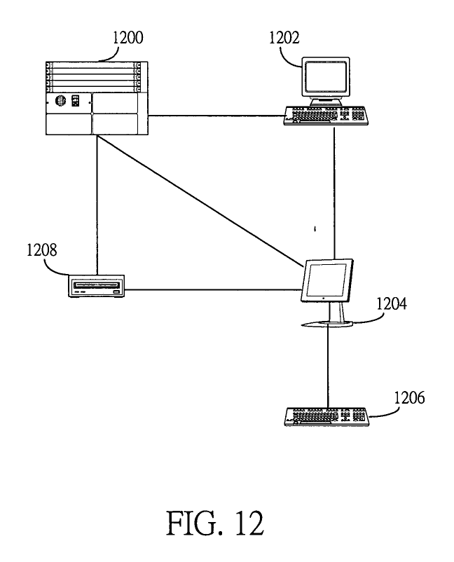

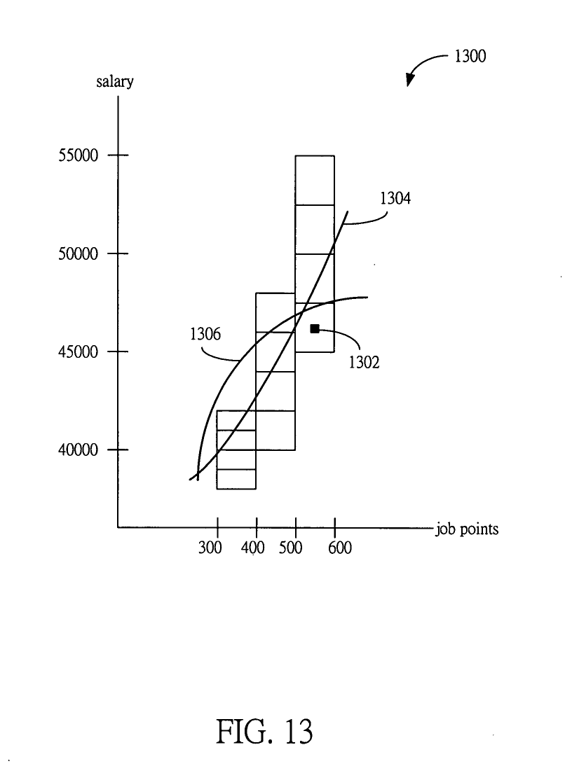

The regression analysis device 1208 is configured to generate a regression line according to the compensation datum of each reference entity, i.e., each current engineer, and the target entity. FIG. 13 shows a second portion 1300 of the display device 1204. When the executive inputs a compensation datum for the target entity through the input device 1206, the second portion 1300 will instantaneously display a rectangular point 1302 denoting the target entity in the coordinate plane; meanwhile, the regression analysis device 1208 derives a regression line 1304 according to all of the current engineers and the target entity. For instance, when a new engineer joins the R&D department, the executive may observe thereby how the salary or pay status of the engineer, i.e., the salary or pay status of the target entity affects the salary trend of the R&D department. If the database 1200 stores market data for the same jobs, the regression analysis device 1208 may generate a market regression line 1306 according to the market data. With reference to the regression line 1304 and the market regression line 1306, the executive may observe the deviation of the salary trend between the R&D department of the company and the R&D departments of other companies in the same business.

### Seventh Embodiment

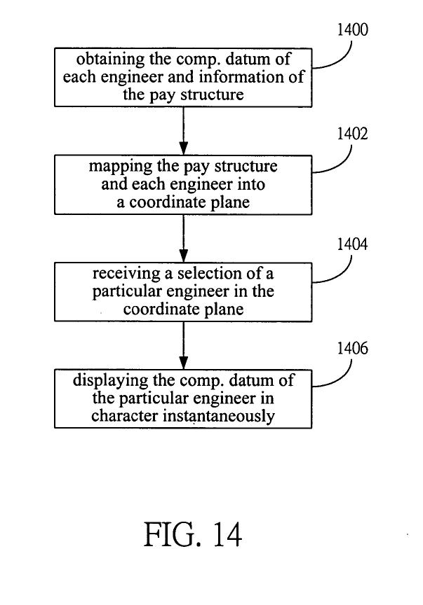

The seventh embodiment of the present invention is a method for analyzing a salary or pay status of a particular entity in contrast with a pay structure in character and in graph simultaneously. The particular entity is a member of a group, e.g., an engineer of an R&D department. Each member of the group, including the particular entity, has a corresponding compensation datum. As FIG. 14 shows, the method includes the following steps. In step 1400, obtaining the compensation datum of each engineer of the R&D department and information of the pay structure is executed, wherein the pay structure is preestablished for the R&D department. In step 1402, mapping the pay structure and each engineer of the R&D department into a coordinate plane is executed. In step 1404, receiving a selection of a particular engineer in the coordinate plane is executed. The selection is made, for example, by moving a mouse pointer onto the point denoting the particular engineer in the coordinate plane. In step 1406, displaying the compensation datum of the particular engineer in character instantaneously is executed.

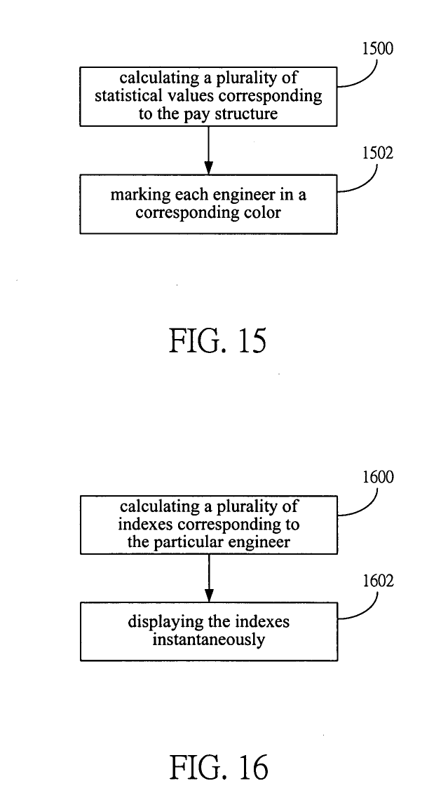

As FIG. 15 shows, step 1402 further includes the following steps. In step 1500, calculating a plurality of statistical values corresponding to the pay structure is executed. In step 1502, marking each engineer of the R&D department in a corresponding color according to the plurality of statistical values is executed.

The method may also display some indexes related to the particular engineer. As FIG. 16 shows, the method further includes steps executed after the step of calculating a plurality of statistical values (step 1500) is executed. In step 1600, calculating a plurality of indexes corresponding to the particular engineer according to the plurality of statistical values is executed, wherein the indexes include the aforementioned compa-ratio and penetration-ratio. In step 1602, displaying the indexes instantaneously is executed.

To provide more information, after the step of calculating a plurality of statistical values (step 1500) is executed, the method further includes a step of displaying at least one of the plurality of statistical values which include a salary maximum, a third quartile, a midpoint, a first quartile, a salary minimum, a range spread and a midpoint progression.

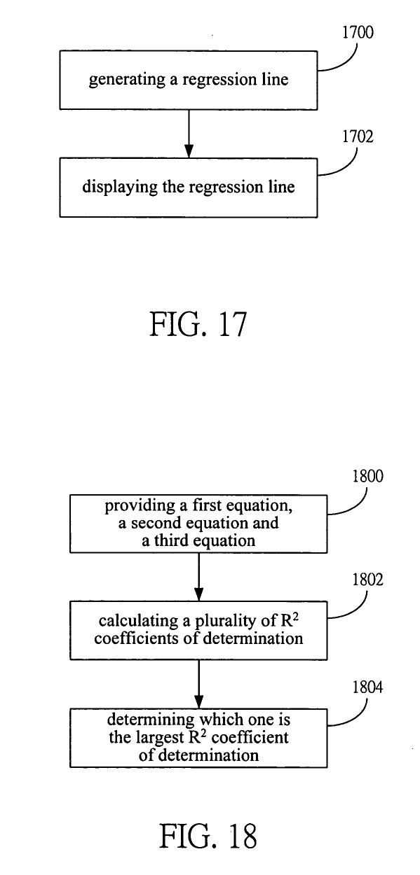

Besides, the method may display a regression line associated with all of the engineers simultaneously. As FIG. 17 shows, the method further includes the following steps. In step 1700, generating a regression line according to the compensation datum of each engineer of the R&D department is executed. In step 1702, displaying the regression line is executed.

Step 1700, as FIG. 18 shows, further includes the following steps. In step 1800, providing a first equation, a second equation and a third equation is executed. In step 1802, calculating a plurality of R² coefficients of determination according to the compensation datum of each engineer of the R&D department is executed, wherein the plurality of R² coefficients of determination include a first R² coefficient of determination corresponding to the first equation, a second R² coefficient of determination corresponding to the second equation, and a third R² coefficient of determination corresponding to the third equation. In step 1804, determining which one is the largest one of the first, second and third R² coefficients of determination is executed. The regression line represents the equation with the largest R² coefficient of determination. The first, second and third equations may be a linear equation, a quadratic equation, a cubic equation, an exponential equation or a logarithmic equation, respectively.

### Eighth Embodiment

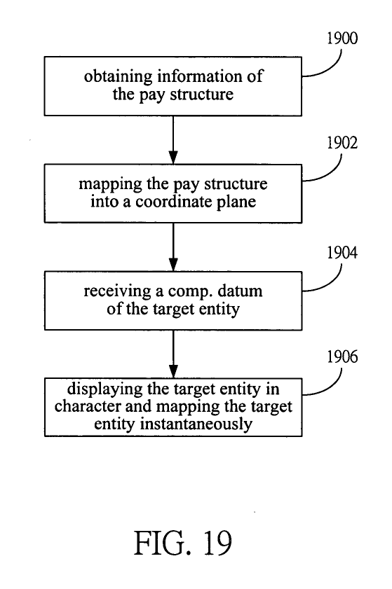

The eighth embodiment of the present invention is a method for instantaneously analyzing a salary or pay status of a target entity, e.g., a newly employed engineer, in contrast with a pay structure. As FIG. 19 shows, the method includes the following steps. In step 1900, obtaining information of the pay structure is executed. In step 1902, mapping the pay structure into a coordinate plane is executed. In step 1904, receiving a compensation datum of the target entity is executed, wherein the compensation datum includes job points and a salary. In step 1906, displaying the target entity in character and mapping the target entity into the coordinate plane instantaneously is executed.

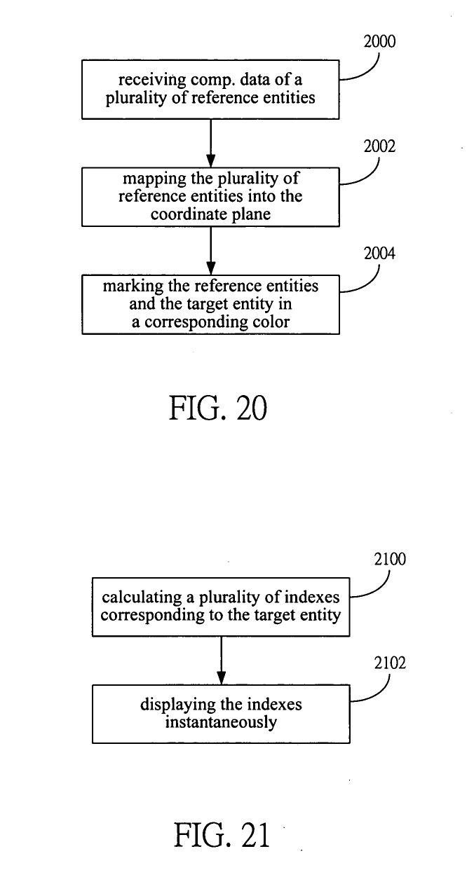

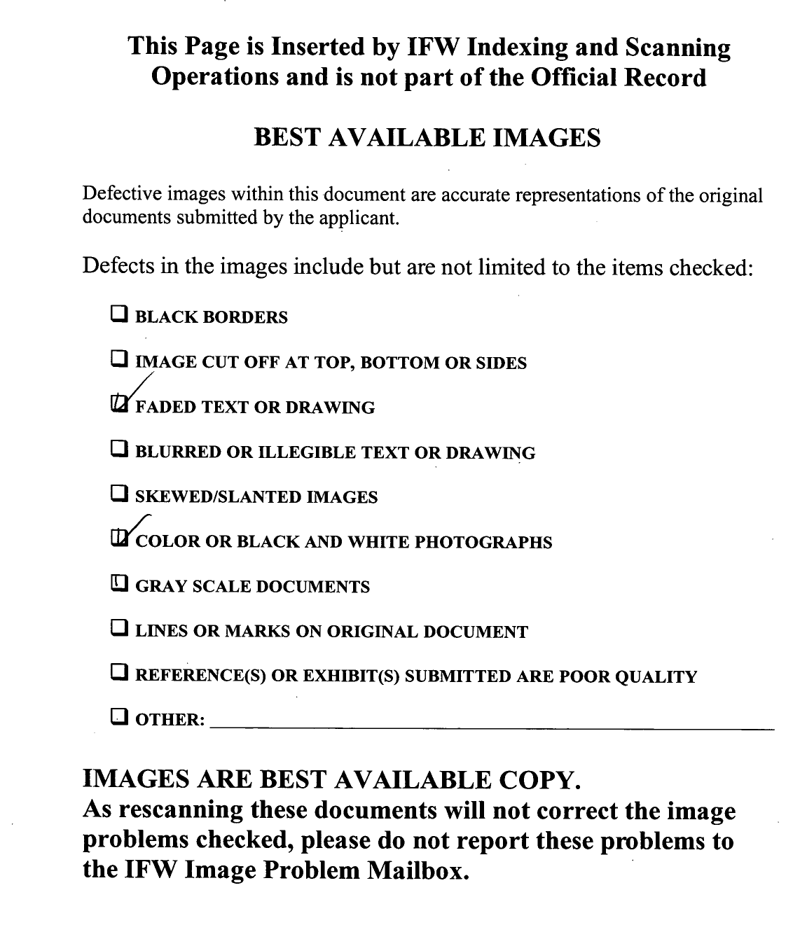

As FIG. 20 shows, the method further includes the following steps. In step 2000, receiving compensation data of a plurality of reference entities is executed, wherein the reference entities and the target entity belong to the same group, e.g., an R&D department. In step 2002, mapping the plurality of reference entities into the coordinate plane is executed. In step 2004, marking the target entity and the reference entities in a corresponding color in the coordinate plane according to the pay structure is executed.

The method may also include steps 1700, 1702, 1800, 1802, and 1804 as shown in FIGS. 17 and 18 to generate and instantaneously display a regression line. The regression line is derived based on the compensation data of the target entity and the reference entities.

The method may also display some indexes related to the target entity. As FIG. 21 shows, the method further includes step 2100 of calculating a plurality of indexes corresponding to the target entity according to the pay structure and step 2102 of displaying the indexes instantaneously, wherein the indexes include the aforementioned compa-ratio and penetration-ratio.

### Ninth Embodiment

The ninth embodiment of the present invention is a computer program product for performing the method of the seventh embodiment as well as the system operations of the first, second, and third embodiments. The computer program product includes a computer readable storage medium which has computer readable program code embodied therein. The computer readable program code is configured to instruct a computer to execute the steps of the seventh embodiment and the system operations of the first, second, and third embodiments. The computer readable storage medium may be a hard disk, a soft disk, a magnetic tape, a compact disk, a USB flash drive, a database on the Internet, or any kind of device capable of storing electronic data.

### Tenth Embodiment

The tenth embodiment of the present invention is a computer program product for performing the method of the eighth embodiment as well as the system operations of the fourth, fifth, and sixth embodiments. The computer program product includes a computer readable storage medium which has computer readable program code embodied therein. The computer readable program code is configured to instruct a computer to execute the steps of the eighth embodiment and the system operations of the fourth, fifth, and sixth embodiments. The computer readable storage medium may be a hard disk, a soft disk, a magnetic tape, a compact disk, a USB flash drive, a database on the Internet, or any kind of device capable of storing electronic data.

Although all of the pay structures of the above-mentioned embodiments are preestablished for employees or certain jobs of a company, the present invention does not confine that the pay structure must be preestablished. For example, the pay structure may be developed by external market data so the second portion includes a coordinate plane with at least a mapped percentile bar representing an average, a third quartile, a maximum, a first quartile and a minimum compensation in the same business. An executive of the company may hence observe the deviation between the compensation of an entity and the above-indexed compensation by referring to the coordinate plane. If the pay structure denotes market data, the indexes related to the above-mentioned particular entity may further include a market salary index and an index of salary relative to market which may be derived based on the following equations:
market salary index=salary of the particular entity/average salary in the market
index of salary relative to market=average salary in the market/salary of the particular entity

The particular entity of the above embodiments may be a particular group instead of a single employee. For example, the particular entity is all engineers in the same pay grade in an R&D department and the salary of the particular entity is an average salary of the group. In this circumstance, the second portion may show a coordinate plane with the average salary of the group and a preestablished pay structure, or a market structure, and the salary information in the first portion includes a group title and the average compensation of the group.

Although the x-coordinate of the second portion in the above-mentioned embodiments uses a unit of job points, the present invention does not confine to this. For example, the x-coordinate may denote a unit of seniority, a unit of experience, a unit of sales volumes.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A compensation analysis system for analyzing a pay status of a particular entity in contrast with a pay structure, the particular entity having a corresponding compensation datum, the compensation analysis system comprising:
a database for storing the compensation datum and information of the pay structure;
a first calculation device for calculating a plurality of statistical values according to the pay structure; and
a display device for simultaneously displaying a first portion and a second portion, the first portion comprising the compensation datum, the second portion comprising a coordinate plane showing the plurality of statistical values and the compensation datum.

2. The compensation analysis system of claim 1, wherein the particular entity is a member of a group, each member of the group has a corresponding compensation datum, and the database stores the compensation datum of each member of the group.

3. The compensation analysis system of claim 2, wherein the pay structure is a preestablished pay structure of the group.

4. The compensation analysis system of claim 2, wherein each member of the group is marked in a corresponding color in the coordinate plane according to the plurality of statistical values.

5. The compensation analysis system of claim 2, further comprising a regression analysis device for generating a regression line according to the compensation datum of each member of the group, wherein the second portion comprises the regression line.

6. The compensation analysis system of claim 5, wherein the regression analysis device presets a first equation, a second equation and a third equation, the regression analysis device calculates a first R² coefficient of determination corresponding to the first equation, a second R² coefficient of determination corresponding to the second equation, and a third R² coefficient of determination corresponding to the third equation according to the compensation datum of each member of the group, and the regression line represents the equation with the largest one among the first, second and third R² coefficients of determination.

7. The compensation analysis system of claim 1, wherein the plurality of statistical values comprise a midpoint, a range spread, a salary maximum, a salary minimum, a first quartile, and a third quartile.

8. The compensation analysis system of claim 1, further comprising a second calculation device for calculating a plurality of indexes corresponding to the particular entity according to the plurality of statistical values, wherein the display device simultaneously displays a third portion comprising the plurality of indexes.

9. The compensation analysis system of claim 8, wherein the plurality of indexes comprise a compa-ratio and a penetration-ratio.

10. The compensation analysis system of claim 1, wherein the display device simultaneously displays a fourth portion comprising at least one of the plurality of statistical values.

11. The compensation analysis system of claim 1, wherein the pay structure is a market pay structure.

12. The compensation analysis system of claim 1, wherein the particular entity is an employee, and the compensation datum comprises a name, job points, an employee number and a compensation.

13. The compensation analysis system of claim 1, wherein the particular entity is a group and the compensation datum comprises a group title and an average compensation.

14. A compensation analysis system for a user to instantaneously analyze a pay status of a target entity in contrast with a pay structure, comprising:
a database for storing information of the pay structure;
a first calculation device for calculating a plurality of statistical values according to the pay structure;
an input device for the user to input a compensation datum of the target entity; and
a display device for simultaneously displaying a first portion and a second portion, the first portion comprising the compensation datum, the second portion comprising a coordinate plane showing the plurality of statistical values and the compensation datum.

15. The compensation analysis system of claim 14, wherein the database stores a plurality of compensation data respectively corresponding to a plurality of reference entities.

16. The compensation analysis system of claim 15, wherein the reference entities and the target entity are marked in a corresponding color in the coordinate plane according to the plurality of statistical values.

17. The compensation analysis system of claim 15, further comprising a regression analysis device for generating a regression line according to the compensation data of the reference entities and the target entity, wherein the second portion comprises the regression line.

18. The compensation analysis system of claim 17, wherein the regression analysis device presets a first equation, a second equation and a third equation, the regression analysis device calculates a first R² coefficient of determination corresponding to the first equation, a second R² coefficient of determination corresponding to the second equation, and a third R² coefficient of determination corresponding to the third equation according to the compensation data of the target entity and the reference entities, and the regression line represents the equation with the largest one among the first, second and third R² coefficients of determination.

19. The compensation analysis system of claim 14, further comprising a second calculation device for calculating a plurality of indexes corresponding to the target entity according to the plurality of statistical values, wherein the display device simultaneously displays a third portion comprising the plurality of indexes.

20. The compensation analysis system of claim 19, wherein the plurality of indexes comprise a compa-ratio and a penetration-ratio.

21. The compensation analysis system of claim 14, wherein the display device simultaneously displays a fourth portion comprising at least one of the plurality of statistical values.

22. The compensation analysis system of claim 14, wherein the compensation datum comprises a pay grade and a compensation.

23. The compensation analysis system of claim 14, wherein the input device is one of a mouse and a keyboard.

24. A computer program product for analyzing a pay status of a particular entity in contrast with a pay structure, the particular entity being a member of a group, each member of the group having a corresponding compensation datum, the computer program product comprising:
a computer readable storage medium having computer readable program code embodied therein, the computer readable program code comprising:
code for obtaining the compensation datum of each member of the group and information of the pay structure;
code for mapping the pay structure and each member of the group into a coordinate plane;
code for receiving a selection of the particular entity in the coordinate plane; and
code for displaying the compensation datum of the particular entity.

25. The computer program product of claim 24, wherein the pay structure is a preestablished pay structure of the group.

26. The computer program product of claim 24, wherein the mapping code comprises:
code for calculating a plurality of statistical values corresponding to the pay structure; and
code for marking each member of the group in a corresponding color according to the plurality of statistical values.

27. The computer program product of claim 24, wherein the computer readable program code further comprises:
code for calculating a plurality of indexes corresponding to the particular entity according to the plurality of statistical values; and
code for displaying the plurality of indexes.

28. The computer program product of claim 25, wherein the plurality of indexes comprise a compa-ratio and a penetration-ratio.

29. The computer program product of claim 24, wherein the computer readable program code further comprises code for displaying at least one of the plurality of statistical values.

30. The computer program product of claim 24, wherein the computer readable program code further comprises:
code for generating a regression line according to the compensation datum of each member of the group; and
code for displaying the regression line.

31. The computer program product of claim 30, wherein the generating code comprises:
code for providing a first equation, a second equation and a third equation;
code for calculating a first R² coefficient of determination corresponding to the first equation, a second R² coefficient of determination corresponding to the second equation, and a third R² coefficient of determination corresponding to the third equation according to the compensation datum of each member of the group; and
code for determining which one is the largest one among the first, second and third R² coefficients of determination;
wherein the regression line represents the equation with the largest R² coefficient of determination.

32. A computer program product for instantaneously analyzing a pay status of a target entity in contrast with a pay structure, the computer program product comprising:
a computer readable storage medium having computer readable program code embodied therein, the computer readable program code comprising:
code for obtaining information of the pay structure;
code for mapping the pay structure into a coordinate plane;
code for receiving a compensation datum of the target entity; and
code for instantaneously displaying the target entity in character and mapping the target entity into the coordinate plane.

33. The computer program product of claim 32, wherein the computer readable program code further comprises:
code for receiving compensation data of a plurality of reference entities; and
code for mapping the plurality of reference entities into the coordinate plane.

34. The computer program product of claim 33, wherein the computer readable program code further comprises:
code for marking the reference entities and the target entity in a corresponding color in the coordinate plane according to the pay structure.

35. The computer program product of claim 33, wherein the computer readable program code further comprises:
code for generating a regression line according to the compensation data of the reference entities and the target entity; and
code for displaying the regression line.

36. The computer program product of claim 35, wherein the generating code comprises:
code for providing a first equation, a second equation and a third equation;
code for calculating a first R² coefficient of determination corresponding to the first equation, a second R² coefficient of determination corresponding to the second equation, and a third R² coefficient of determination corresponding to the third equation according to the compensation data of the reference entities and the target entity; and
code for determining which one is the largest one among the first, second and third R² coefficients of determination;
wherein the regression line represents the equation with the largest R² coefficient of determination.

37. The computer program product of claim 32, further comprising:
code for calculating a plurality of indexes corresponding to the target entity according to the pay structure; and
code for displaying the plurality of indexes.

38. The computer program product of claim 37, wherein the plurality of indexes comprise a compa-ratio and a penetration-ratio.

39. The computer program product of claim 32, wherein the compensation datum comprises job points and a compensation.

40. A method for analyzing a pay status of a particular entity in contrast with a pay structure, the particular entity being a member of a group, each member of the group having a corresponding compensation datum, the method comprising the steps of:
obtaining the compensation datum of each member of the group and information of the pay structure;
mapping the pay structure and each member of the group into a coordinate plane;
receiving a selection of the particular entity in the coordinate plane; and
displaying the compensation datum of the particular entity.

41. The method of claim 40, wherein the mapping step comprises:
calculating a plurality of statistical values corresponding to the pay structure;
marking each member of the group in a corresponding color according to the plurality of statistical values;
calculating a plurality of indexes corresponding to the particular entity according to the plurality of statistical values; and
displaying the plurality of indexes.

42. The method of claim 40, further comprising the steps of:
generating a regression line according to the compensation datum of each member of the group; and
displaying the regression line.

43. A method for instantaneously analyzing a pay status of a target entity in contrast with a pay structure, comprising the steps of:
obtaining information of the pay structure;
mapping the pay structure into a coordinate plane;
receiving a compensation datum of the target entity; and
displaying the target entity in character and mapping the target entity into the coordinate plane instantaneously.

44. The method of claim 43, further comprising the steps of receiving compensation data of a plurality of reference entities;
mapping the plurality of reference entities into the coordinate plane;
marking the reference entities and the target entity in a corresponding color in the coordinate plane according to the pay structure.

45. The method of claim 43, further comprising the steps of:
receiving compensation data of a plurality of reference entities;
mapping the plurality of reference entities into the coordinate plane;
generating a regression line according to the compensation data of the reference entities and the target entity; and
displaying the regression line.
